(19) United States
(12) Patent Application Publication
(10) Pub. No.: US 2023/0080258 A1
(43) Pub. Date: Mar. 16, 2023

(54) BATTERY SYSTEM WITH CYLINDRICAL BATTERY CELLS AND RIBBON BONDING

(71) Applicant: Kitty Hawk Corporation, Palo Alto, CA (US)

(72) Inventors: Evan E. Frank, Los Altos Hills, CA (US); BinBin Chi, Fremont, CA (US); Xu Yan, San Francisco, CA (US)

(21) Appl. No.: 17/940,396

(22) Filed: Sep. 8, 2022

Related U.S. Application Data
(60) Provisional application No. 63/242,690, filed on Sep. 10, 2021.

(51) Int. Cl. H01M 50/514; H01M 10/613; H01M 10/625; H01M 10/6554; H01M 10/643; H01M 50/522; H01M 10/653

(52) U.S. Cl. CPC H01M 50/514; H01M 10/613; H01M 10/625; H01M 10/6554; H01M 10/643; H01M 50/522; H01M 10/653; H01M 2220/20

(57) ABSTRACT

A system which includes a plurality of cylindrical battery cells that have a uniform orientation, where each of the plurality of cylindrical battery cells has a first planar surface and a second planar surface. There is also a thermal management and structural (TMS) plate that is disposed at the second planar surface of the plurality of cylindrical battery cells and a bonding plate that is disposed at the first planar surface of the plurality of cylindrical battery cells. At least some electrical connections between the plurality of cylindrical battery cells and the bonding plate include ribbon bonding.

### CROSS REFERENCE TO OTHER APPLICATIONS

This application claims priority to U.S. Provisional Patent Application No. 63/242,690 entitled BATTERY SYSTEM WITH UNIFORMLY-ORIENTED CELLS filed Sep. 10, 2021 which is incorporated herein by reference for all purposes.

### BACKGROUND OF THE INVENTION

An attractive feature of electric vertical takeoff and landing (eVTOL) vehicles is their ability to land in relatively small spaces without the need for a runway. To make eVTOL vehicles even more attractive, developers are working to increase the flight range and/or time of eVTOL vehicles. New battery systems that are better able to meet the increased demands of longer range eVTOL vehicles would be desirable.

### BRIEF DESCRIPTION OF THE DRAWINGS

Various embodiments of the invention are disclosed in the following detailed description and the accompanying drawings.

FIG. 1 is a flowchart illustrating an embodiment of a process for providing a system that includes cylindrical battery cells, a bonding plate, and a thermal management and structural (TMS) plate.

FIG. 2 is a diagram illustrating an embodiment of a portion of a battery pack with cylindrical battery cells, a bonding plate, a thermal management and structural (TMS) plate, and a cover.

FIG. 3A is a diagram illustrating an embodiment of electrical connections to the cylindrical battery cells.

FIG. 3B is a zoomed-in diagram illustrating an embodiment of ribbon bonding between adjacent cylindrical battery cells.

FIG. 4 illustrates an embodiment of a battery pack from two perspective views.

FIG. 5 is a diagram illustrating an embodiment of an electric vertical takeoff and landing (eVTOL) aircraft with pusher tiltrotors.

FIG. 6 is a diagram illustrating an embodiment of an electric vertical takeoff and landing (eVTOL) aircraft with tractor tiltrotors and pusher tiltrotors.

FIG. 7 is a diagram illustrating an embodiment of a battery system location in an eVTOL aircraft.

FIG. 8 is a diagram illustrating an external view of an eVTOL aircraft embodiment that includes a battery system.

FIG. 9 is a diagram illustrating an embodiment of a battery system that includes six battery packs with a bonding plate to bonding plate arrangement.

FIG. 10 is a diagram illustrating an embodiment of a battery system that includes six battery packs with a thermal management and structural (TMS) plate to TMS plate arrangement.

FIG. 11A is a diagram illustrating an embodiment of a battery system with reusable battery disconnect units (BDUs) at a first point in time.

FIG. 11B is a diagram illustrating an embodiment of a battery system with reusable battery disconnect units (BDUs) in a second state.

FIG. 11C is a diagram illustrating an embodiment of a battery system with reusable battery disconnect units (BDUs) in a third state.

FIG. 11D is a diagram illustrating an embodiment of a battery system with the reusable battery disconnect units (BDUs) decoupled.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various embodiments of battery systems and/or battery packs that are better able to handle the relatively large current draws associated with eVTOL vehicles are described herein. In some embodiments, such a battery system and/or battery pack includes cylindrical battery cells which are surrounded on one side by a thermal management and structural (TMS) plate and on the other side by a bonding plate is described herein, where at least some electrical connections between the cylindrical battery cells and the bonding plate are ribbon bonded. As will be described in more detail below, ribbon bonds have a higher melting point than some other types of bonding, such as wire bonds. As will be described in more detail below, in some embodiments, a battery system and/or battery pack includes other components, characteristics, and/or features that are beneficial and/or attractive for (e.g., long(er) range) eVTOL aircraft.

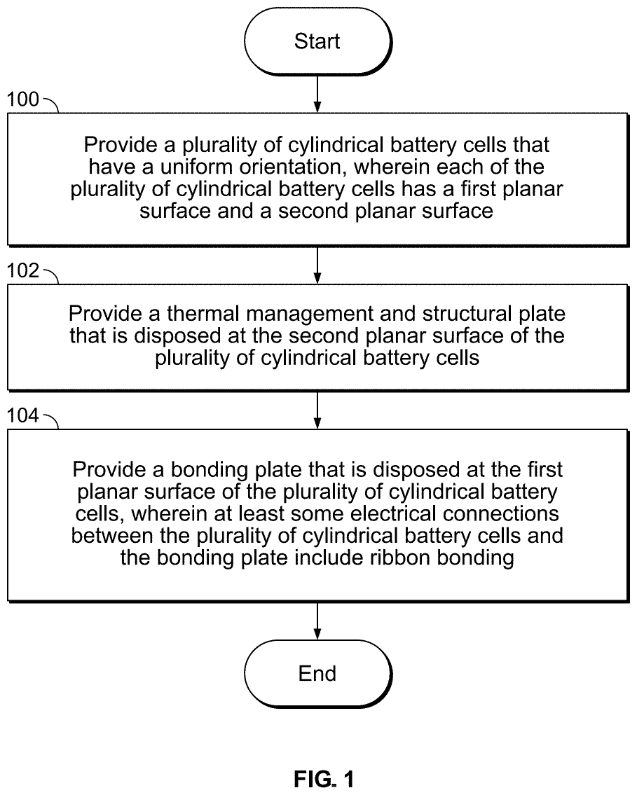

FIG. 1 is a flowchart illustrating an embodiment of a process for providing a system that includes cylindrical battery cells, a bonding plate, and a thermal management and structural (TMS) plate. In some embodiments, the process of FIG. 1 is performed by a battery pack, where a battery system includes one or more battery packs, where each battery pack has its own set of cylindrical battery cells, a bonding plate, a TMS plate, a cover, a battery disconnect unit (BDU), etc.

At 100, a plurality of cylindrical battery cells that have a uniform orientation is provided, wherein each of the plurality of cylindrical battery cells has a first planar surface and a second planar surface. Cylindrical battery cells have two planar surfaces (i.e., the first planar surface and the second planar surface) and one of those planar surfaces has the positive and negative terminals of the cylindrical battery cell. As used herein, the term “uniformly oriented” means that all of the cylindrical battery cells are oriented so that the planar surfaces with the positive and negative terminals are all facing in the same direction (e.g., all facing up, all facing down, etc.).

At 102, a thermal management and structural (TMS) plate is provided that is disposed at the second planar surface of the plurality of cylindrical battery cells. The TMS plate provides structural support for the battery system and is used to thermally manage the cylindrical battery cells by drawing heat from the cylindrical battery cells, through the TMS plate, and out of the battery system. To that end, in some embodiments, the TMS plate is made of a rigid material that is thermally conductive such as aluminum with a thickness that is within a range of 1 mm and 10 mm, inclusive. For example, for eVTOL aircraft applications, this/these material(s) and range of thicknesses are attractive because they provide a good balance of thermal conductivity and structural rigidity versus weight.

At 104, a bonding plate is provided that is disposed at the first planar surface of the plurality of cylindrical battery cells, wherein at least some electrical connections between the plurality of cylindrical battery cells and the bonding plate include ribbon bonding. As will be shown in more detail below, in some embodiments, the bonding plate is formed or is cut to expose the positive and negative terminals of the cylindrical battery cells while still holding the cylindrical battery cells in place.

In some embodiments, the bonding plate is made of aluminum or copper and has a thickness that is within a range of 0.5 mm and 2 mm, inclusive. These materials and range of thicknesses may be desirable for eVTOL aircraft applications because they provide a good balance of ease of bonding and/or structural rigidity versus weight.

Some other battery systems use wire bonds. In some applications (e.g., electric vertical takeoff and landing (eVTOL) vehicles) there may be corner cases or situations where wire bonds are undesirable because of their melting point. For example, some eVTOL aircrafts can operate in both a hovering flight mode and a forward flight mode (e.g., during which wing-borne flight is performed) and there may be situations in which the eVTOL aircraft remains in hovering mode for a relatively long time. This can draw a relatively large amount of current from the battery system for a sustained period of time and cause a wire bond to fail. For electric cars, this may simply cause the battery system to fail, but in an electric aircraft this could cause a crash.

Another corner case to consider for eVTOL aircraft is if one of the battery packs in the system fails. In a battery pack out situation, an electric aircraft would need to rely upon the remaining battery packs to travel to a safe place to land. For eVTOL aircraft, performing a vertical landing is already very demanding on a fully-functional battery system. With a battery pack out, the remaining battery packs would see an increase in the current draw (which was already high to begin with for vertical landings) and this increased current draw could potentially melt a wire bond.

Ribbon bonds have a lower weld resistance and higher current carry capacity and are therefore better able to handle the high(er) current draws demanded by eVTOL aircraft, especially in the situations described above. The battery embodiments and/or techniques described herein may therefore be preferred over some other types of battery systems (e.g., that are designed for electric cars and/or use wire bonds). In some embodiments, a ribbon (e.g., used in ribbon bonding) has one or more of the following properties: is made of aluminum or copper, has a length that is less than or equal to 30 mm, and is pre-processed before ribbon bonding to produce a less reflective surface. For example, the pre-processing may reduce the reflectiveness of the surface of the ribbon (e.g., producing a more matte surface as opposed to a shiny or reflective surface) so that the ribbon is better able to absorb the laser during the bonding process. A variety of physical (e.g., sanding, cutting, etc.) and/or chemical (e.g., etching with a chemical) processes may be used during pre-processing to achieve the desired (e.g., matte) effect on the ribbon.

As for the range of ribbon lengths specified above, a longer ribbon increases the impedance or resistance through the ribbon and the heat generated correspondingly increases. For some prototypes of the battery systems that were designed for certain target eVTOL aircraft described herein, the lengths are long enough to achieve the desired bonds while still keeping the amount of heat generated by the ribbon bonds (e.g., for the current draw(s) of the target eVTOL aircraft(s)) at an acceptable level.

In some embodiments, the ribbon bonding process is automated and is performed by an off-the-shelf bonding machine (i.e., not a custom-built one). This is desirable in many applications because it keeps production costs down. In various embodiments, the material is used for the bonding plate and/or the ribbon bond is/are selected to aid in the (automated) ribbon bonding process by the off-the-shelf bonding machine. As described above, in some embodiments, the bonding plate and/or the ribbon bond is treated, plated, or otherwise pre-processed to help the subsequent (automated) ribbon bonding process.

It may be helpful to illustrate an example arrangement of the components recited in FIG. 1. The following figures show one such example.

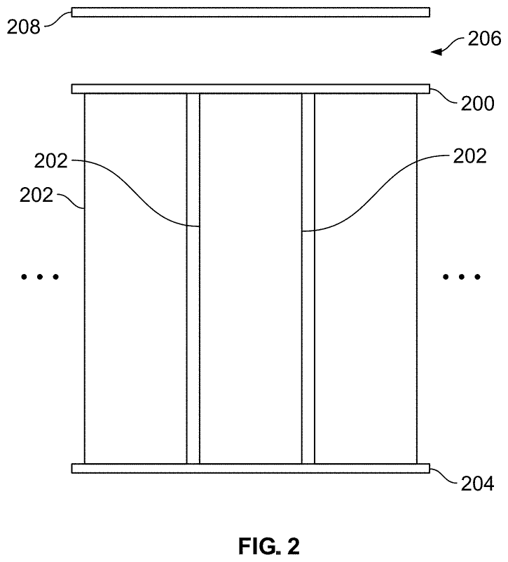

FIG. 2 is a diagram illustrating an embodiment of a portion of a battery pack with cylindrical battery cells, a bonding plate, a thermal management and structural (TMS) plate, and a cover. In this example, the bonding plate (200) is coupled to or otherwise disposed at the top planar surface of the battery cells (202) and the TMS plate (204) is coupled to or otherwise disposed at the bottom planar surface of the battery cells (202).

In this example, the cylindrical battery cells (202) are bonded onto the TMS plate (204) so that the TMS plate provides both structural support and thermal conductivity. In some embodiments, the cylindrical battery cells are bonded to the TMS plate using a thermally-conductive and electrically-insulated adhesive (such as an epoxy). This permits heat to travel through the adhesive and exit the battery system via the TMS plate, without (electrically) shorting out the cells via the electrically-insulating adhesive.

In this example, there is a gap (206) for airflow and/or venting (e.g., of gases and/or heat released during a thermal runaway event or other catastrophic failure) between the bonding plate (200) and the cover (208) of the battery pack. During normal operation, heat may be dissipated via the bonding plate (200) and/or the gap (206) that exists between the cover (208) and the bonding plate (200). Should any of the cylindrical battery cells (202) experience a catastrophic failure (e.g., which would cause a large and/or dangerous amount of gas and/or heat to be released), the heat and/or gas can be vented through the gap (206). If needed, the bonding plate and/or any substrate surrounding the cylindrical battery cells can be designed to break and/or puncture to help release heat and/or gas via the gap (206). In this example, the bonding plate (like the TMS plate) provides structural support and/or rigidity for the battery pack.

In some embodiments, a thermally-insulating foam is injected between the cylindrical battery cells (202) which prevents heat transfer from cell to cell, which is helpful for normal operation. In the event of thermal runaway, the foam can also help to prevent adjacent cells from likewise going into thermal runaway. Furthermore, the foam expands after injection, adding structural rigidity which reduces the impact of external vibrations. The foam also acts as an electrical insulator, preventing electrical shorting between adjacent cells.

In some embodiments, there is an adhesive between the tops of the cylindrical battery cells (202) and the bonding plate (200) that helps to disperse heat should thermal runaway happen. In some embodiments, a potting material is used to prevent shorting in the event of thermal runaway. Specifically, a cell experiencing thermal runaway may rain down hot gases, liquid metals, and/or other ejecta on the tops of adjacent cells and the potting material or other adhesive protects the tops of the adjacent cells. Furthermore, during normal operation, the potting material surrounds the cell-to-cell interconnects which keeps these interconnects cooler (i.e., the thermal conductivity is greater than that of air) and permits a larger current flow (corresponding to higher heat dissipation) to flow through the cell-to-cell interconnects. Furthermore, the potting material prevents corrosion and dampens vibrations experienced by the cell-to-cell interconnects. In some embodiments, the potting material is dispensed or otherwise deposited after ribbon bonding.

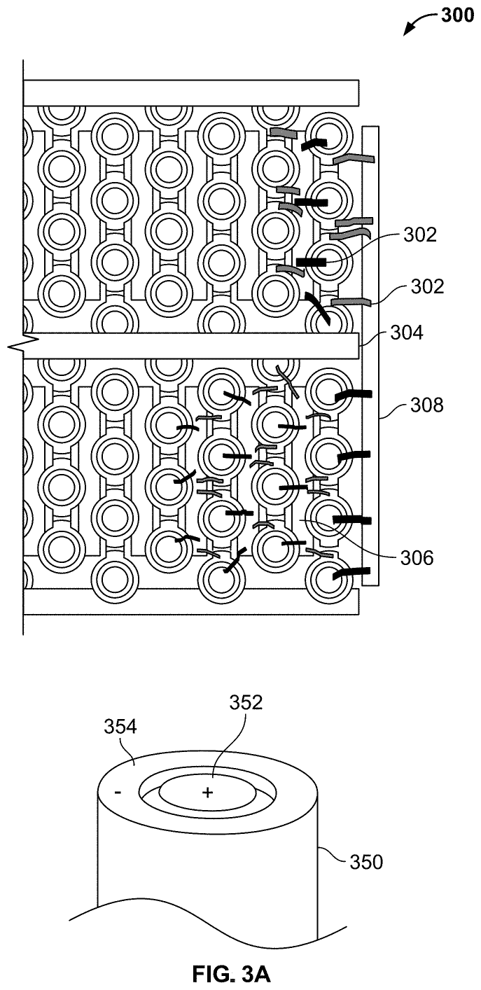

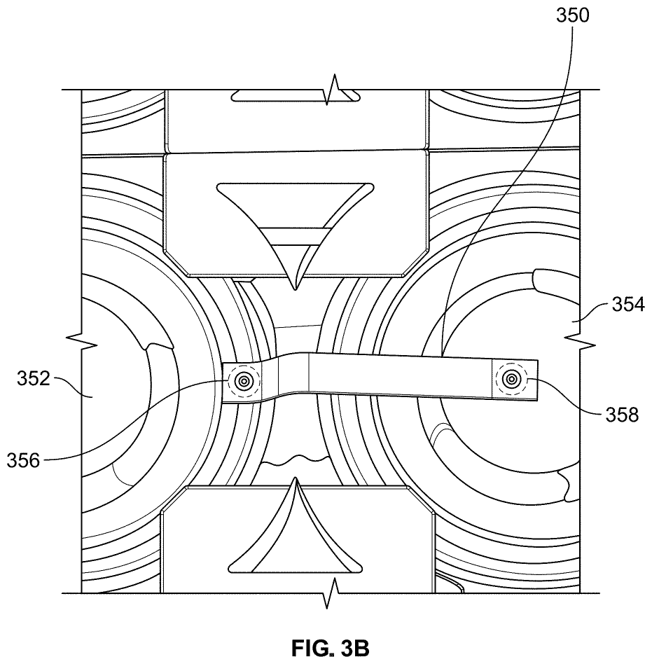

FIG. 3A is a diagram illustrating an embodiment of electrical connections to the cylindrical battery cells. In this example, the top diagram (300) shows the uniform orientation of the cylindrical battery cells (e.g., they are all facing or oriented the same way) and some of the ribbon bonds (302) that are used to connect them. In this example, parts of the bonding plate are also shown, including the horizontal voltage sense flex circuits (304) to which (ribbon) bonds are connected to current collectors (306) of the cells for voltage sensing. The bonding plate also includes (in this diagram, vertical) current collectors (306) which are located between rows of cylindrical battery cells and to which ribbon bonds are formed. The boding plate also includes a longer (vertical) current collector (308) to which ribbon bonds are (also) formed.

The perspective view of the cylindrical battery cell (350) at the bottom shows that the centers of the cell tops are the positive terminals (352) and the cell rims or edges are the negative terminals (354).

In some embodiments, the ribbon bonds are hybrid laser ribbon bonds where the ribbons are connected from cell to cell or from cell to current collectors. Hybrid laser ribbon bonds may be attractive in at least some applications because of their low electrical weld resistance, strong mechanical connection, and the ability to carry large currents.

FIG. 3B is a zoomed-in diagram illustrating an embodiment of ribbon bonding between adjacent cylindrical battery cells. In this example, a metal ribbon (350) connects the negative terminal of the cylindrical battery cell at left (352) with the positive terminal of the cylindrical battery cell at right (354). Lasers were applied at the ends of the ribbon (356 and 358) to form the bonds.

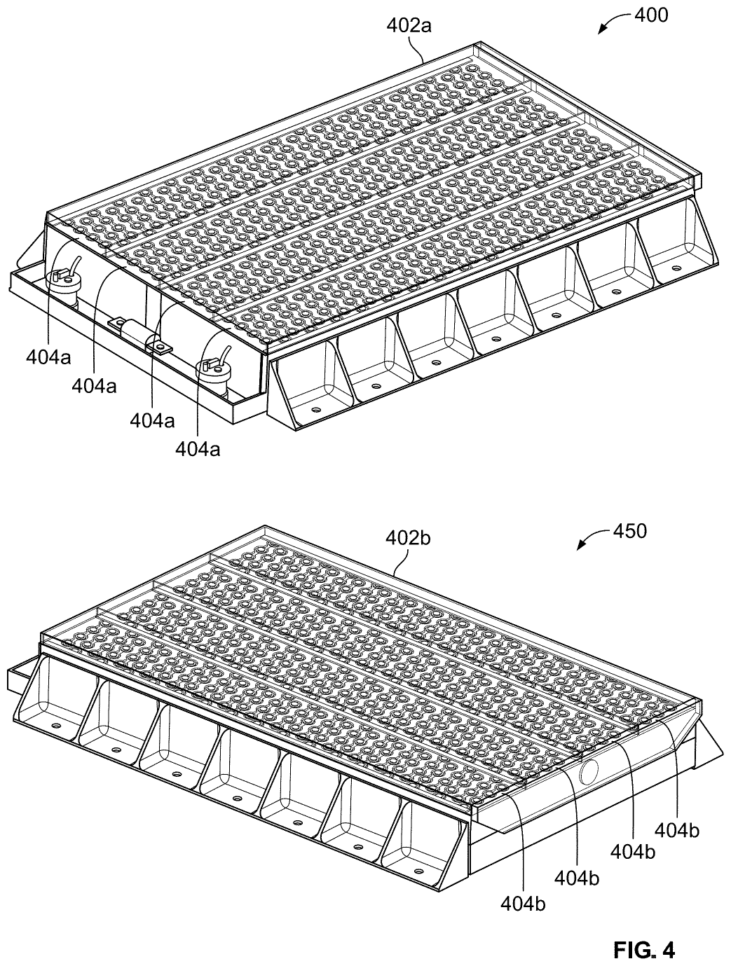

FIG. 4 illustrates an embodiment of a battery pack from two perspective views. In this example, the top diagram (400) shows a first perspective view of the battery pack with the side where a battery disconnect unit (BDU) goes; the bottom diagram (450) shows a second perspective view of the same battery pack with the battery disconnect unit (BDU) side hidden. In this example, the battery pack is shown with a cover (402a and 402b) on the top, above the positive and negative terminals of the cylindrical battery cells and the bonding plate, forming a gap between those components and which permits airflow. It is noted, for example, that the cover has openings (404a and 404b) for air to enter and exit the battery pack.

In some embodiments, a battery pack includes a finned plate, sometimes referred to as a heat sink. In one example, a finned plate has 50 fins, each fin of which is 7 mm tall x 550 mm deep. In some embodiments, the finned plate is combined with some other element in the battery pack (e.g., a TMS plate, a cover, a bonding plate, etc.). Depending upon the application, a finned plate or heat sink may be desirable (e.g., space permitting and if more heat dissipation is desired than is available with just a TMS plate).

The following figures describe some eVTOL aircraft for which the battery system embodiments described herein were developed. It is noted that the battery systems described herein are not necessarily limited to the eVTOL aircraft described below and may be used in other vehicles.

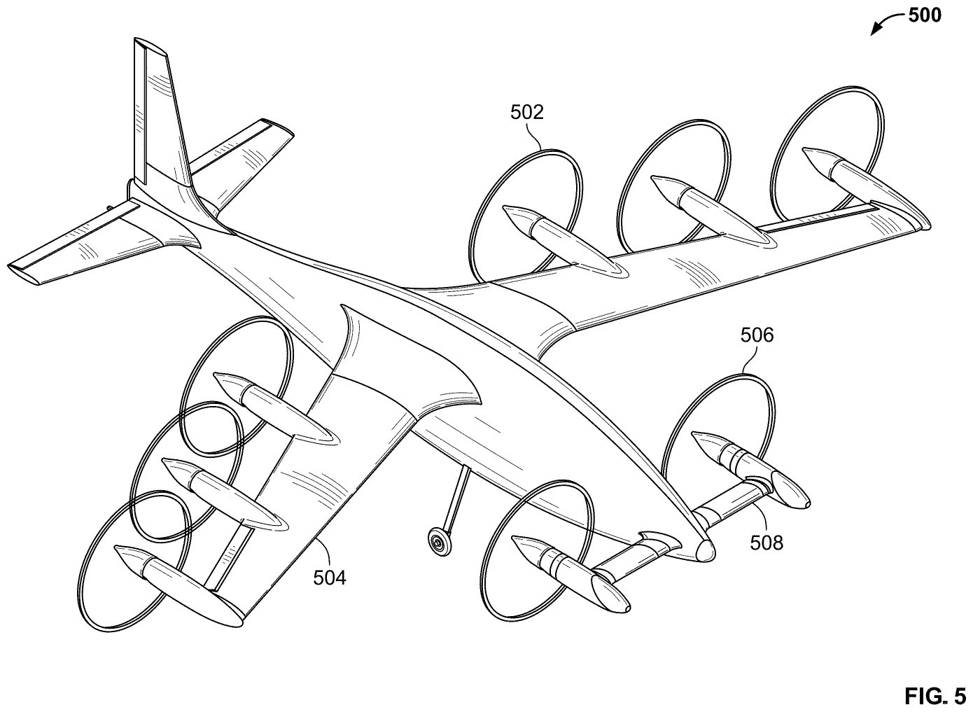

FIG. 5 is a diagram illustrating an embodiment of an electric vertical takeoff and landing (eVTOL) aircraft with pusher tiltrotors. In this example, the eVTOL aircraft (500) has six pusher tiltrotors (502) that are aft of the main wing (504) and attached via pylons. Similarly, there are two canard pusher tiltrotors (506) that are aft of the canard (508) and attached via pylons. This eVTOL aircraft (500) is relatively small (e.g., with seats for at most two occupants) and has a relatively small footprint.

In the state shown here, the tiltrotors (502 and 506) are in the forward flight position. During vertical takeoff and landing (i.e., during hover flight mode), the tiltrotors (502 and 506) would be rotated downwards (not shown) so that the propeller blades rotate around a substantially vertical axis of rotation.

A subsequent version of this eVTOL aircraft was developed that (among other things) reduced assembly and/or manufacturing costs. The following figure describes this version in more detail.

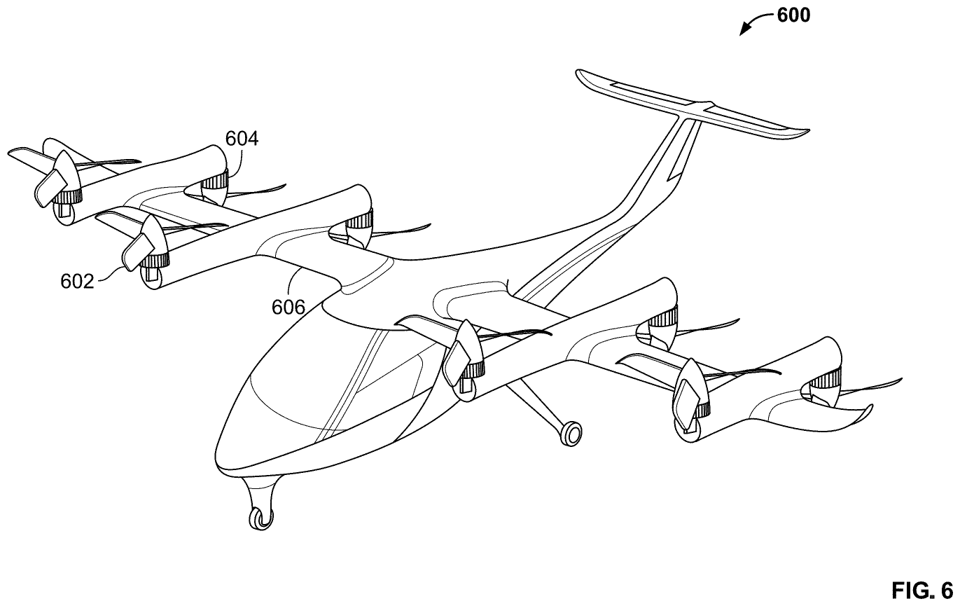

FIG. 6 is a diagram illustrating an embodiment of an electric vertical takeoff and landing (eVTOL) aircraft with tractor tiltrotors and pusher tiltrotors. In this example, the eVTOL aircraft (600) has four tractor tiltrotors (602) and four pusher tiltrotors (604), all of which are attached to the main wing (606) via pylons. The tractor tiltrotors (602) are located forward of the main wing (606) and the pusher tiltrotors (604) are located aft of the main wing (606).

The relatively small footprint and VTOL ability of the above vehicles makes them attractive for use in an air taxi service in suburban and urban environments. In that application, the vehicles would be performing many (vertical) takeoffs and (vertical) landings, drawing large amounts of current from the battery systems many times over the course of a day. In some cases, the vehicles may have to wait in hover mode while a takeoff and landing spot is occupied. For these reasons, other types of battery systems (e.g., designed for electric cars and/or with wire bonding) are ill suited for the above eVTOL aircraft and/or an air taxi application. In contrast, the battery system embodiments and/or techniques described herein can support the eVTOL aircraft described above and/or potential applications (e.g., air taxi service).

As shown in the examples above, in some embodiments, the battery system is included in an electric vertical takeoff and landing (eVTOL) aircraft that includes a fixed wing (e.g., the forward-swept main wing (504) in FIG. 5 and the straight main wing (606) in FIG. 6) and at least one pusher tiltrotor (e.g., pusher tiltrotor (502) in FIG. 5 and pusher tiltrotor (604) in FIG. 6). As shown in the example of the FIG. 6, in some such embodiments, the eVTOL aircraft further includes at least one tractor tiltrotor (e.g., tractor tiltrotor (602) in FIG. 6).

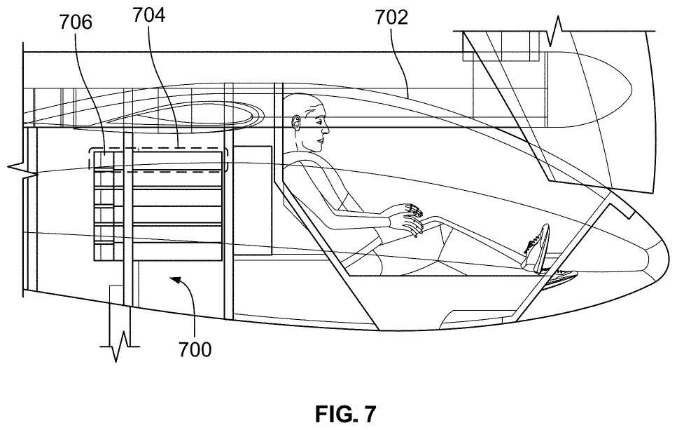

FIG. 7 is a diagram illustrating an embodiment of a battery system location in an eVTOL aircraft. In the example shown, the battery system (700) is located in the fuselage behind the cockpit (702). In this example, the battery system (700) is a 6-pack battery system where each layer of the battery system is a battery pack (e.g., 704). The battery system (700) is orientated with the battery disconnect unit (BDU) (706) facing towards the tail of the aircraft. In this example, the battery system is oriented in this way (i.e., with the BDU (706) facing towards the tail of the aircraft) for ease of (e.g., electrical) connections.

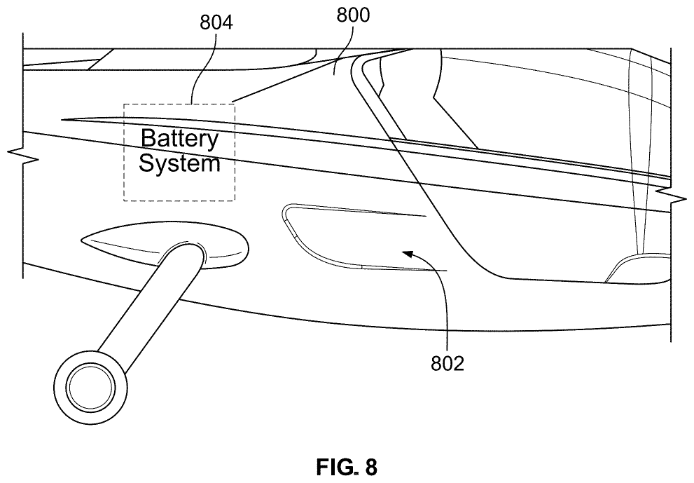

FIG. 8 is a diagram illustrating an external view of an eVTOL aircraft embodiment that includes a battery system. FIG. 8 continues the example of FIG. 7. In this example, the side of the fuselage (800) has intake ducts (802) to air cool the battery system (804) in the fuselage.

In some embodiments, when the vehicle is on the ground, a (e.g., portable) ground cooling and/or heating station or unit is used to cool and/or heat the battery system by blowing cooled and/or heated air or other coolant over and/or through the battery system.

As described above, a battery system includes one or more battery packs. The following figures describe some example arrangements and/or configurations of battery packs in a battery system.

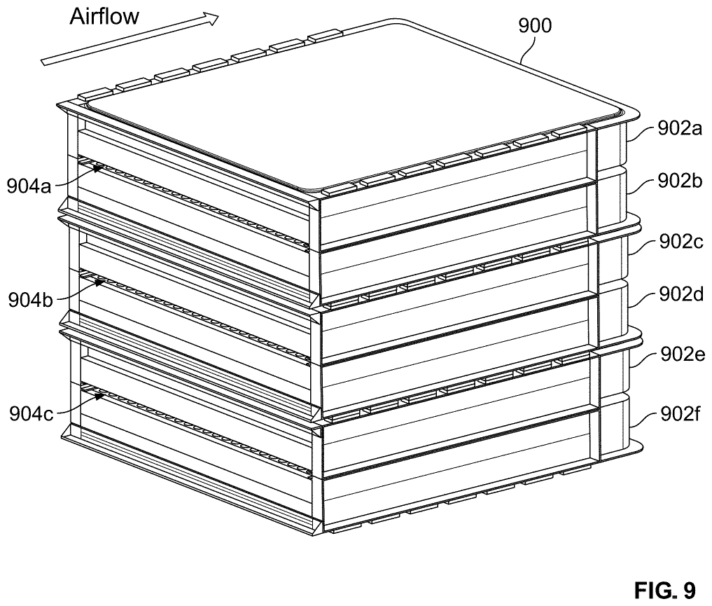

FIG. 9 is a diagram illustrating an embodiment of a battery system that includes six battery packs with a bonding plate to bonding plate arrangement. In the example shown, the battery system (900) includes six battery packs (902a-902f) where each layer of the battery system includes a single battery pack. In this example, each of the battery packs is identical in layout and composition.

In this example, the battery packs are paired up (e.g., 902a with 902b, 902c with 902d, and so on) with the bonding plates facing each other for a given pair. This creates a gap (e.g., 904a-904c) between each pair of battery packs such that there are three cooling and/or heating inputs via which air enters the battery system and cools (or heats, in cold weather) the cylindrical battery cells contained in the battery packs. For example, these gaps (904a-904c) correspond to the air gap (206) shown in FIG. 2.

Although it may not be apparent from this view, the exemplary battery system shown here is a cell-to-pack configuration with no (e.g., interior) compartments and/or modules. For example, this may reduce the total weight and/or cost associated with parts.

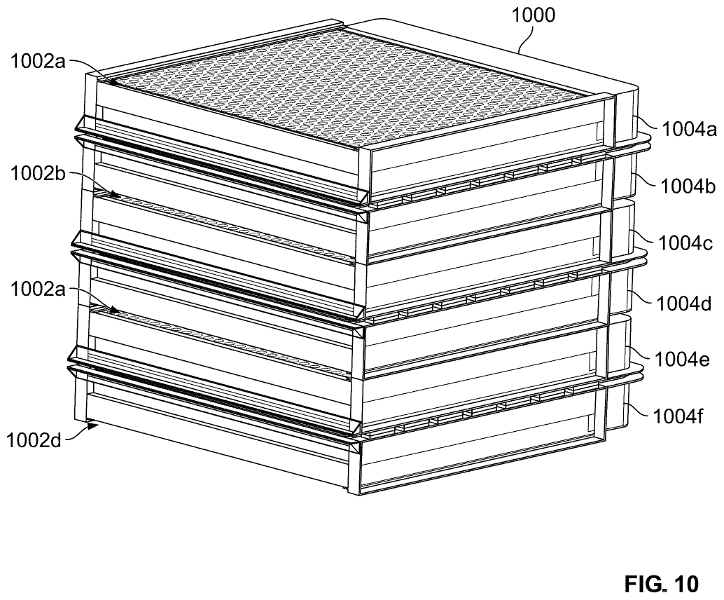

FIG. 10 is a diagram illustrating an embodiment of a battery system that includes six battery packs with a thermal management and structural (TMS) plate to TMS plate arrangement. In this example, the battery packs in the battery system (1000) are arranged so that there are four gaps (1002a-1002d) for cooling and/or heating in contrast to the three gaps (904a-904c) shown in FIG. 9. The battery packs are paired up (e.g., 1004a with 1004b, 1004c with 1004d, and so on) with their TMS plates facing each other. To more clearly show certain elements of the exemplary battery system, some of the covers are not shown in this diagram.

In some applications, the arrangement shown in FIG. 10 is preferred over the arrangement shown in FIG. 9 because the former arrangement provides a better crush or crash structure over the latter arrangement (e.g., to better protect the cylindrical battery cells from shock loading during a crash or hard landing).

Depending upon the application (e.g., space constraints, desired flight range, etc.), the number of battery packs which are used in a battery system may vary. For example, some other embodiments may have one, two, four, or eight battery packs (as examples) in a battery system instead of six.

With use, cylindrical battery cells wear out and the battery system will eventually need to be replaced. As described above, each battery pack includes a BDU which manages that pack. These BDU modules or units are relatively expensive, for example, on the order of $1,500. To keep costs down, the battery packs are designed with an eye to reusing the BDU. The following figures show an example of how battery packs are assembled so that the BDU can be removed from an old battery pack without being damaged and reused in a new battery pack with fresh cylindrical battery cells.

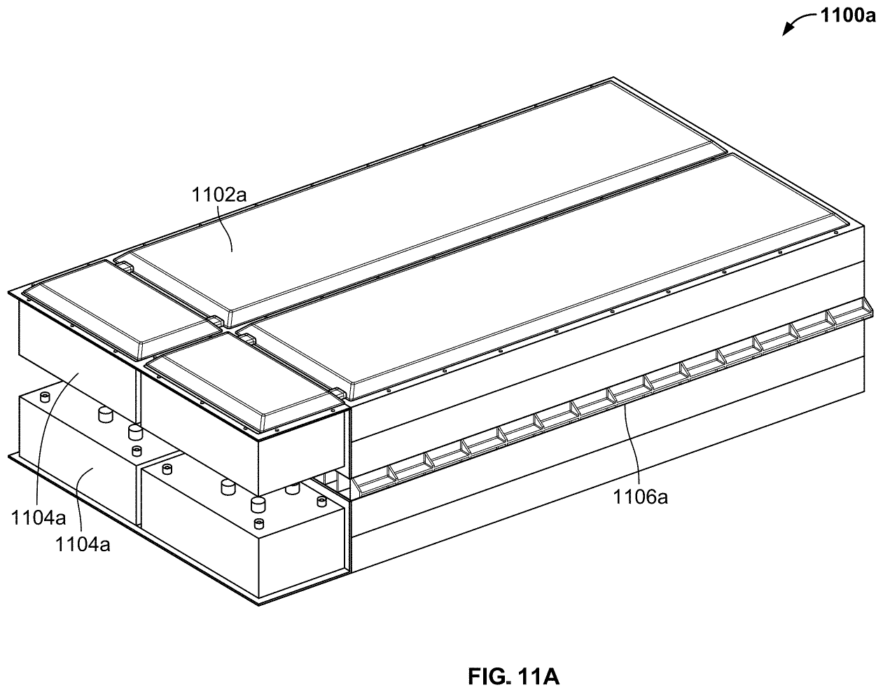

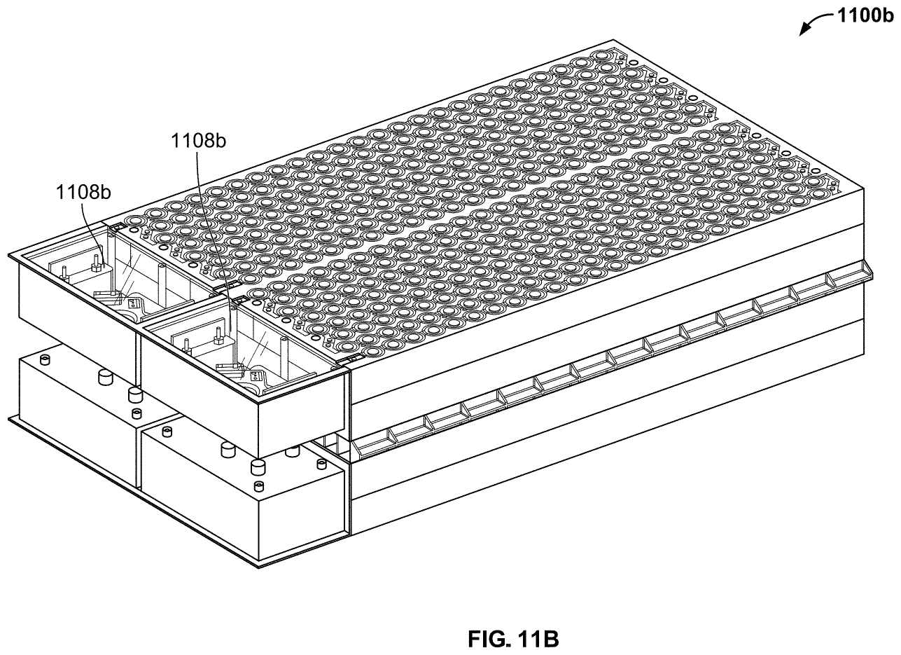

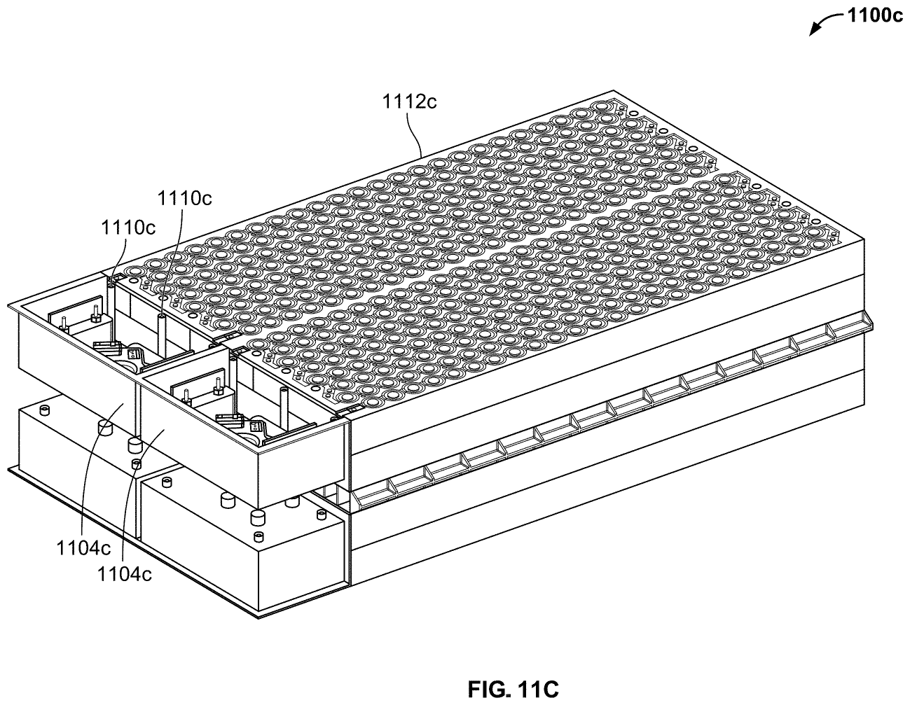

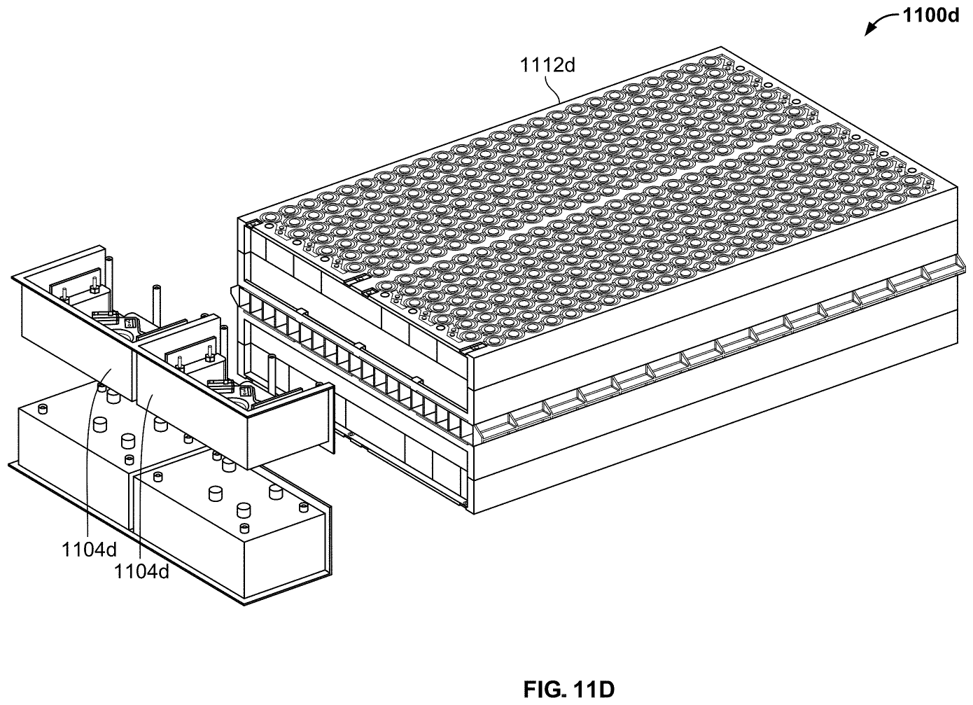

FIG. 11A is a diagram illustrating an embodiment of a battery system with reusable battery disconnect units (BDUs) at a first point in time. In this example, the battery system (1100a) includes four battery packs with two battery packs per level. In this view, the pack lids (1102a) and BDUs (1104a) of the four battery packs are shown. In this configuration, the TMS plates (1106a) are facing each other.

In some embodiments, a BDU (e.g., 1104a) performs battery management processes and/or operations. For example, each BDU may include voltage and temperature sensors to monitor performance and/or detect any battery failures. The BDU may include and control a variety of contactors and/or fuses (e.g., to electrically connect the battery packs together or disconnect a selected battery pack from the rest should one of the battery packs fail). A BDU may also have high voltage (e.g., for the propellers) and low voltage connectors (e.g., for avionics and/or other electronics), as well as associated voltage management, sensing, and/or other circuitry for state estimation.

FIG. 11B is a diagram illustrating an embodiment of a battery system with reusable battery disconnect units (BDUs) in a second state. FIG. 11B continues the example of FIG. 11A and shows the same battery system (1100b) but with the pack lids removed.

FIG. 11C is a diagram illustrating an embodiment of a battery system with reusable battery disconnect units (BDUs) in a third state. In this example, the BDU lids (see, e.g., 1108b in FIG. 11B) have been removed from the battery system (1100c) to better show the contents of the BDUs (1104c). The BDUs (1104c) are detachably coupled to the non-BDU halves (1112c) of the battery packs using screws that are inserted into cell housing (1110c). The following figure shows the battery packs with the screws removed and the reusable BDUs decoupled from the rest of the battery packs.

FIG. 11D is a diagram illustrating an embodiment of a battery system with the reusable battery disconnect units (BDUs) decoupled. In this example, the four BDUs (1104d) have been decoupled from the non-BDU halves (1112d) in the battery system (1100d). The BDUs (1104d) can then be reused with fresh cylindrical battery cells and the worn out cylindrical battery cells can be discarded.

In some embodiments, if an odd number of battery packs is desired but the arrangement has two or more battery packs per layer (as shown in this example), one of the frames and/or cases of a battery pack is left empty (i.e., without cylindrical battery cells, etc.).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a plurality of cylindrical battery cells that have a uniform orientation, wherein each of the plurality of cylindrical battery cells has a first planar surface and a second planar surface;
a thermal management and structural (TMS) plate that is disposed at the second planar surface of the plurality of cylindrical battery cells; and
a bonding plate that is disposed at the first planar surface of the plurality of cylindrical battery cells, wherein at least some electrical connections between the plurality of cylindrical battery cells and the bonding plate include ribbon bonding.

2. The system recited in claim 1, wherein the TMS plate is made of aluminum and has a thickness that is within a range of 1 mm and 10 mm, inclusive.

3. The system recited in claim 1, wherein the bonding plate is made of aluminum or copper and has a thickness that is within a range of 0.5 and 2 mm, inclusive.

4. The system recited in claim 1, wherein a ribbon that is used in the ribbon bonding has one or more of the following properties: is made of aluminum or copper, has a length that is less than or equal to 30 mm, and is pre-processed before the ribbon bonding to produce a less reflective surface.

5. The system recited in claim 1, wherein the system is included in an electric vertical takeoff and landing (eVTOL) aircraft that includes: (1) a fixed wing and (2) at least one pusher tiltrotor.

6. The system recited in claim 1, wherein the system is included in an electric vertical takeoff and landing (eVTOL) aircraft that includes: (1) a fixed wing, (2) at least one pusher tiltrotor, and (3) at least one tractor tiltrotor.

7. The system recited in claim 1, further including a reusable battery disconnect unit (BDU).

8. A method, comprising:
providing a plurality of cylindrical battery cells that have a uniform orientation, wherein each of the plurality of cylindrical battery cells has a first planar surface and a second planar surface;
providing a thermal management and structural (TMS) plate that is disposed at the second planar surface of the plurality of cylindrical battery cells; and
providing a bonding plate that is disposed at the first planar surface of the plurality of cylindrical battery cells, wherein at least some electrical connections between the plurality of cylindrical battery cells and the bonding plate include ribbon bonding.

9. The method recited in claim 8, wherein the TMS plate is made of aluminum and has a thickness that is within a range of 1 mm and 10 mm, inclusive.

10. The method recited in claim 8, wherein the bonding plate is made of aluminum or copper and has a thickness that is within a range of 0.5 and 2 mm, inclusive.

11. The method recited in claim 8, wherein a ribbon that is used in the ribbon bonding has one or more of the following properties: is made of aluminum or copper, has a length that is less than or equal to 30 mm, and is pre-processed before the ribbon bonding to produce a less reflective surface.

12. The method recited in claim 8, wherein the method is performed by an electric vertical takeoff and landing (eVTOL) aircraft that includes: (1) a fixed wing and (2) at least one pusher tiltrotor.

13. The method recited in claim 8, wherein the method is performed by an electric vertical takeoff and landing (eVTOL) aircraft that includes: (1) a fixed wing, (2) at least one pusher tiltrotor, and (3) at least one tractor tiltrotor.

14. The method recited in claim 8, further including providing a reusable battery disconnect unit (BDU).
